(19) United States
(12) Patent Application Publication
(10) Pub. No.: US 2022/0022153 A1
(43) Pub. Date: Jan. 20, 2022

(54) TIMING SYNCHRONIZATION METHOD, TRANSMISSION AND RECEPTION SYSTEM, TRANSMITTER, RECEIVER AND PROGRAM

(71) Applicant: Asahi Kasei Microdevices Corporation, Tokyo (JP)

(72) Inventor: Naohiro HARIGAI, Tokyo (JP)

(21) Appl. No.: 17/367,664

(22) Filed: Jul. 6, 2021

(30) Foreign Application Priority Data
Jul. 14, 2020 (JP) 2020-120868

(51) Int. Cl. H04W 56/00; H04W 4/80

(52) U.S. Cl. CPC H04W 56/0045; H04W 4/80

(57) ABSTRACT

Provided is a timing synchronization method, comprising: setting a transmission period and a delay time of a signal to be transmitted by a transmitter; generating, by the transmitter, a beacon signal in a data format including the transmission period and the delay time; transmitting, by the transmitter, the beacon signal with an event time obtained by adding the delay time to the transmission period; and receiving the beacon signal and determining, by a receiver, a reception timing based on the event time.

The contents of the following Japanese patent applications are incorporated herein by reference:

NO. 2020-120868 filed in JP on Jul. 14, 2020

### BACKGROUND

### 1. Technical Field

The present invention relates to a timing synchronization method, a transmission and reception system, a transmitter, a receiver and a program.

### 2. Related Art

Conventionally, a synchronization method for synchronizing a transmitter with a receiver is well known (for example, refer to Patent Document 1 or 2).
Patent Document 1: Japanese Patent Application Publication No. 2012-142877
Patent Document 2: Japanese Patent Application Publication No. 2013-113618

### SUMMARY

### Brief Description of the Drawings

FIG. 1 illustrates an overview of a configuration of a transmission and reception system 300.

FIG. 2A illustrates one example of a synchronization method by the transmission and reception system 300.

FIG. 2B illustrates one example of an operation flowchart of the transmission and reception system 300.

FIG. 3A illustrates one example of a synchronization method by the transmission and reception system 300.

FIG. 3B illustrates one example of an operation flowchart of the transmission and reception system 300.

FIG. 4 illustrates one example of a synchronization method by the transmission and reception system 300.

FIG. 5A illustrates a packet format of Bluetooth (registered trademark) 5.1.

FIG. 5B illustrates one example of a configuration of a Payload.

FIG. 6A illustrates one example of a timing synchronization method according to a comparative example.

FIG. 6B illustrates one example of a timing synchronization method according to a comparative example.

FIG. 7 illustrates an example of a computer 2200 in which a plurality of aspects of the present invention may be embodied entirely or partially.

### DESCRIPTION OF EXEMPLARY EMBODIMENTS

Hereinafter, the present invention will be described by way of embodiments, but the following embodiments are not intended to limit the invention specified in the range of claims. Also, all combinations of features described in the embodiments are not necessarily essential to solutions of the invention.

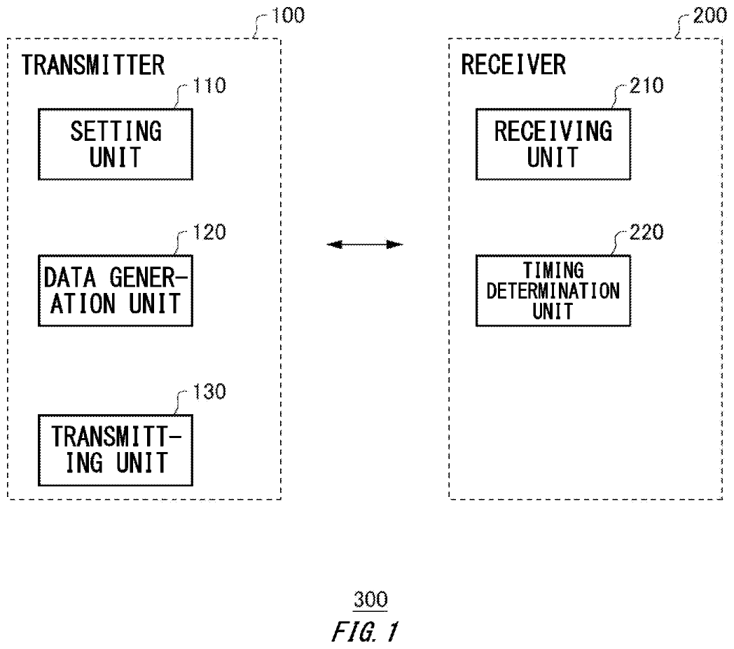

FIG. 1 illustrates an overview of a configuration of a transmission and reception system 300. The transmission and reception system 300 comprises a transmitter 100 and a receiver 200. The transmitter 100 comprises a setting unit 110, a data generation unit 120, and a transmitting unit 130. The receiver 200 comprises a receiving unit 210 and a timing determination unit 220.

The transmitter 100 is one example of a broadcaster for transmitting a beacon signal. The receiver 200 is one example of a scanner or an observer for receiving a beacon signal. The transmitter 100 and the receiver 200 may transmit and receive data in compliance with the Bluetooth Low Energy communication standard.

The setting unit 110 sets a transmission period (advInterval) and a delay time (advDelay) of the signal to be transmitted. The transmission period (advInterval) and the delay time (advDelay) are information about the transmission time interval of the data to be transmitted.

The transmission period (advInterval) is a fixed interval of advertising. In the advertising event, device discovery and connection is performed between the transmitter 100 and the receiver 200. The transmitter 100 transmits the packet signal intermittently. The receiver 200 starts communication with the transmitter 100 if the received packet signal is the desired signal. The receiver 200 may start analyzing the packet of the transmitter 100 if the received packet signal is the desired signal.

The delay time (advDelay) is a non-fixed pseudo-random delay time. By providing the delay time (advDelay), confusion between devices which perform advertising of the same period with the same start timing can be prevented. The delay time (advDelay) is the time between the end of the transmission period (advInterval) and the start of the next transmission period (advInterval).

The data generation unit 120 generates a beacon signal in a data format that includes the transmission period (advInterval) and delay time (advDelay) stored in the payload. The data generation unit 120 may also generate beacon signals of a plurality of channels. For example, the data generation unit 120 generates beacon signals of N channels. The beacon signal may include information about the frequency band for transmission and information related to the transmission interval (chInterval) for each channel. In one example, N is an integer of 3 or less.

The transmitting unit 130 transmits a beacon signal with an event time that is the sum of the transmission period (advInterval) and the delay time (advDelay). The event time is the advertising event time (T_advEvent), which is shown in the following expression. T_advEvent=advInterval+advDelay

The receiving unit 210 receives a beacon signal from the transmitter 100. In other words, the receiving unit 210 receives information about the transmission period (advInterval) and delay time (advDelay) included in the beacon signal. The receiving unit 210 may also receive beacon signals from a plurality of transmitters 100.

The timing determination unit 220 determines a reception timing based on the event time. This allows the receiver 200 to start receiving at a timing that corresponds to the event time (T_advEvent) of the transmitter 100, thereby reducing power consumption.

The transmission and reception system 300 in this example can synchronize the timing with low power consumption by including the transmission period (advInterval) and delay time (advDelay) in the beacon signal. The transmission and reception system 300 can synchronize the timing between a plurality of transmitters 100 and one receiver 200 with low power consumption.

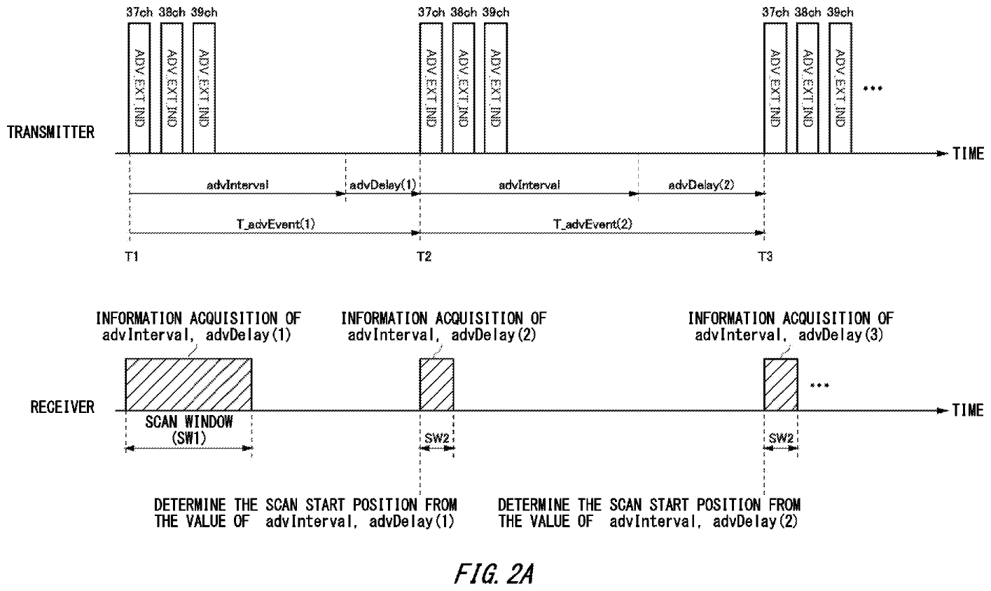

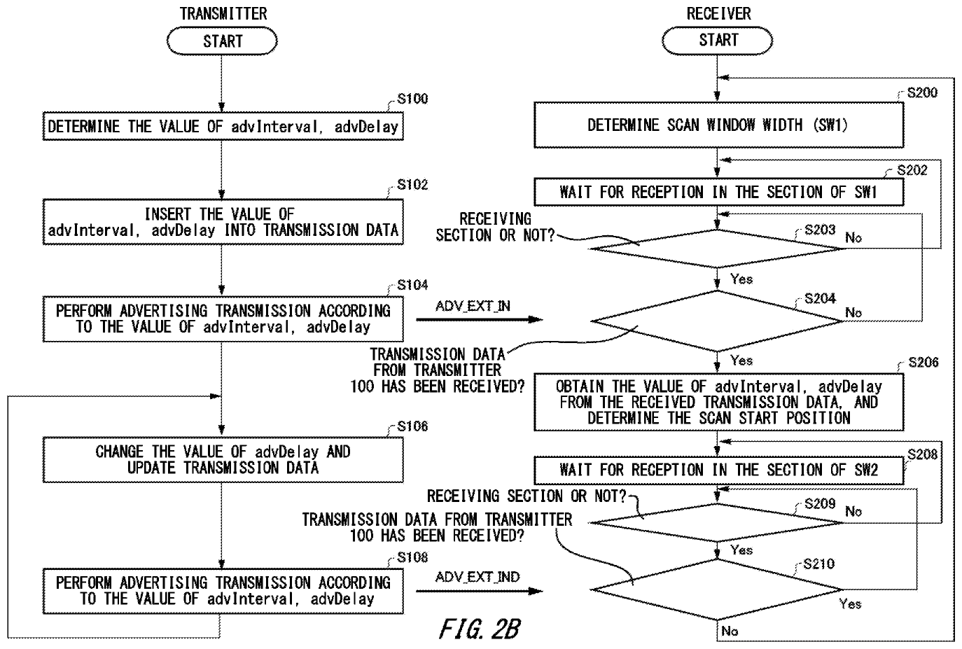

FIG. 2A illustrates one example of a synchronization method by the transmission and reception system 300. The same drawing illustrates one example of a synchronization method between the transmitter 100 and the receiver 200.

The transmitter 100 performs advertising transmission according to the data format of ADV_EXT_IND. ADV_EXT_IND is a data format that enables direction detection by AoA (Angle of Arrival) or AoD (Angle of Departure). AoA and AoD can detect direction by transmitting and receiving a signal while switching the antenna of the receiver or transmitter by a RF switch, and calculating the arrival angle or the transmission angle of the signal. The transmitter 100 of this example transmits by the data format including the information of the transmission period (advInterval) and the delay time (advDelay).

Also, the transmitter 100 changes the delay time (advDelay) and transmits the beacon signal including the changed delay time (advDelay). The receiver 200 receives the beacon signal and determines the reception timing based on the event time (T_advEvent) according to the changed delay time (advDelay).

At time T1, the receiver 200 intermittently waits for reception with a predetermined scan window width (SW1). The receiver 200 receives ADV_EXT_IND, acquires transmission period (advInterval) and delay time (advDelay(1)), and calculates the timing to open the next scan window. The event time (T_advEvent(1)) is indicated by the following expression.

T_advEvent(1)=advInterval+advDelay (1)

Time T2 is the time when the scan window width (SW2) starts waiting for reception. Time T2 is determined according to the event time (T_advEvent(1)), which is acquired by the receiver 200. The scan window width (SW2) is determined based on the received data information. For example, the scan window width (SW2) is determined according to the data length in the packet. The scan window width (SW2) may also be determined by calculating the end time of a CTE (Constant Tone Extension) according to the length of the CTE, which will be described later.

Even after time T3, the scan window may be started at the timing according to the changed delay time (advDelay). In this example, at time T3, the receiver waits for reception with the same scan window width (SW2) as at time T2, but it may wait for reception with a further different scan window width (SW3).

The scan window width is set to the section where the receiver 200 can receive any channel of the 37 ch (2402 MHz), 38 ch (2426 MHz) or 39 ch (2480 MHz) used by the receiver 200. The scan window width (SW2) of this example has its timing and width determined to be able to receive 37 ch. By making the scan window width (SW2) shorter than the scan window width (SW1), low power consumption of the receiver 200 can be achieved. The scan window width (SW2) may be shorter than the event time (T_advEvent).

It is noted that in the transmission and reception system 300 of this example can synchronize the timing with the receiver 200 without any special increase in frequency of the advertising transmission. This allows realizing low power consumption of the transmitter 100 as well as the receiver 200.

FIG. 2B illustrates one example of an operation flowchart of the transmission and reception system 300. This example describes an example of an operation flowchart when executing the timing synchronization method shown in FIG. 2A.

In step S100, determine the transmission period (advInterval) and the delay time (advDelay). In step S102, insert the transmission period (advInterval) and the delay time (advDelay) to the transmission data. In step S104, perform the advertising transmission according to the transmission period (advInterval) and the delay time (advDelay).

In step S106, change the delay time (advDelay) and update the transmission data. For example, after transmitting advDelay(1), change to advDelay(2). In step S108, perform the advertising transmission according to the transmission period (advInterval) and the delay time (advDelay) after changing. Subsequently it is possible to return to step S106.

In step S200, determine the scan window width (SW1). In step S202, wait for reception in the section of scan window width (SW1). In step S203, determine whether it is a receiving section or not. If it is a receiving section, proceed to step S204. If it is not a receiving section, return to step S202. In step S204, determine whether or not the transmission data from the transmitter 100 has been received. If the transmission data from the transmitter 100 has been received, proceed to step S206. If the transmission data from the transmitter 100 has not been received, return to step S203. Even if the transmission data cannot be received in step S204, the delay time (advDelay) is changed to synchronize with the timing when the transmission data can be received. In step S206, the transmission period (advInterval) and delay time (advDelay) are obtained from the received transmission data to determine the scan start time.

In step S208, wait for reception in the section of the scan window width (SW2). In step S209, determine whether it is a receiving section or not. If it is a receiving section, proceed to step S210. If it is not a receiving section, return to step S208. In step S210, determine whether or not the transmission data from the transmitter 100 has been received. If the transmission data from the transmitter 100 has been received, return to step S209. If the transmission data from the transmitter 100 has not been received, return to step S200.

If the transmission data can be received in step S210, it may wait for reception at the timing according to the transmission period (advInterval) and the delay time (advDelay) after changing included in the received transmission data. On the other hand, if it is unable to receive the transmission data in step S210, it may return to intermittent reception with scan window width (SW1).

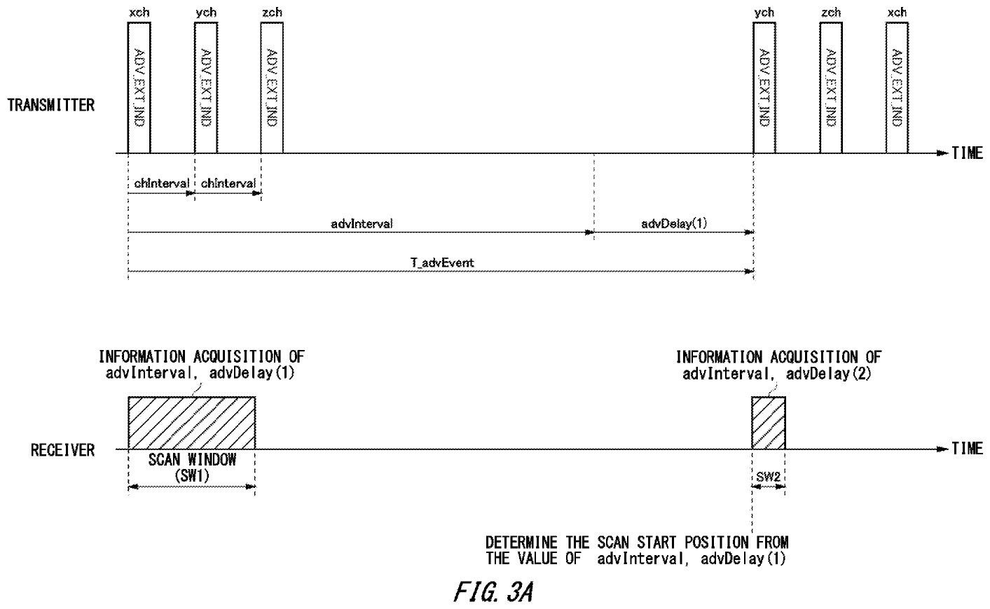

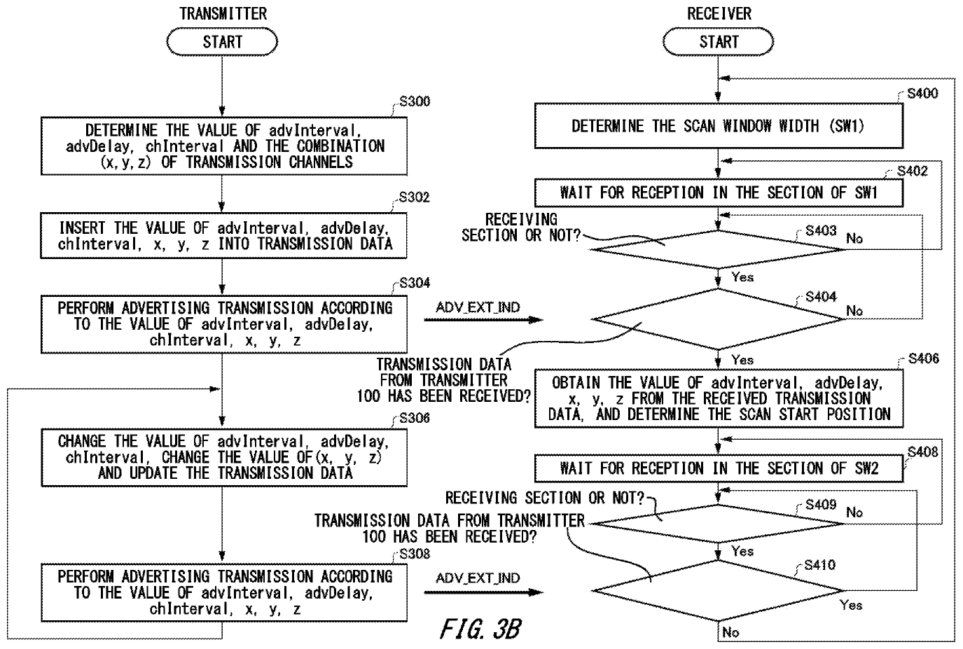

FIG. 3A illustrates one example of a synchronization method by the transmission and reception system 300. In the transmission and reception system 300 of this example, three channels, xch, ych and zch are used for description.

The transmitter 100 generates beacon signals of a plurality of channels. xch, ych and zch are different channels from each other. The xch, ych and zch may be any of the channels of 37 ch, 38 ch or 39 ch. The transmitter 100 transmits the data for each channel at a predetermined transmission interval (chInterval). The transmission interval (chInterval) is the period in which the data for each channel is transmitted.

The transmitter 100 in this example includes information about the transmission period (advInterval), delay time (advDelay), transmission interval (chInterval), and transmission channel combination (x, y, z) in the data format. The transmitter 100 transmits the beacon signal by changing the combination of a plurality of channels. The data format in this example is ADV_EXT_IND, but it is not limited to this. The information on the combination of transmission channels (x, y, z) may include the type of transmission channel and the order in which they are transmitted. For example, the transmitter 100 may include in the data format the current first combination and the second combination to be transmitted next to the first combination as a combination of transmission channels (x, y, z). The first combination in this example is the order of xch, ych and zch. The second combination is the order of ych, zch and xch.

The receiver 200 receives ADV_EXT_IND and obtains the transmission period (advInterval), delay time (advDelay), transmission interval (chInterval), and transmission channel combination (x, y, z) to calculate the timing to open the next scan window. The receiver 200 in this example can wait for reception corresponding to any section of the channel by acquiring the information for the first and second combinations.

The receiver 200 may wait for reception in the section where it can receive either of xch, ych or zch channels. The receiver 200 in this example is waiting for reception in the section where ych is to be received. Since the receiver 200 in this example does not wait for reception in unnecessary sections, low power consumption can be achieved.

The transmission and reception system 300 in this example changes combinations of advertising transmission channels and performs transmission. By randomizing the combination of transmission channels, the randomness of the channel interval can be further improved, further reducing the probability of inter-channel interference and improving communication quality.

FIG. 3B illustrates one example of an operation flowchart of the transmission and reception system 300. This example describes an example of an operation flowchart when executing the timing synchronization method in FIG. 3A.

In step S300, determine the transmission period (advInterval), delay time (advDelay), transmission interval (chInterval) and the combination of transmission channels (x, y, z). In step S302, the combination of transmission period (advInterval), delay time (advDelay), transmission interval (chInterval) and transmission channel (x, y, z) is inserted into the transmission data. The combination of transmission channels may include the current first combination and the second combination to be transmitted next to the first combination. In step S304, advertising transmission according to the combination of transmission period (advInterval), delay time (advDelay), transmission interval (chInterval) and transmission channel (x, y, z).

In step S306, the delay time (advDelay) is changed to change the combination of transmission channels (x, y, z) and update the transmission data. In step S308, advertising transmission according to the combination (x, y, z) of the transmission period (advInterval), the delay time (advDelay) after changing, the transmission interval (chInterval) and the transmission channel after changing. Subsequently it may return to step S306.

In step S400, determine the scan window width (SW1). In step S402, wait for reception in the section of scan window width (SW1). In step S403, determine whether it is the receiving section. If it is a receiving section, proceed to step S404. If it is not a receiving section, return to step S402. In step S404, determine whether or not the transmission data from the transmitter 100 has been received. If the transmission data from the transmitter 100 has been received, proceed to step S406. If the transmission data from the transmitter 100 has not been received, return to step S403. In step S406, the combination of the transmission period (advInterval), delay time (advDelay), transmission interval (chInterval) and transmission channel (x, y, z) is obtained from the received transmission data to determine the scan start time.

In step S408, wait for reception in the section of the scan window width (SW2). In step S409, determine whether or not it is the receiving section. If it is a receiving section, proceed to step S410. If it is not a receiving section, return to step S408. In step S410, determine whether or not the transmission data from the transmitter 100 has been received. If the transmission data from the transmitter 100 has been received, return to step S409. If the transmission data from the transmitter 100 has not been received, return to step S400.

If the transmission data can be received in step S410, the receiver may wait for reception at the timing according to the combination (x, y, z) of the transmission period (advInterval), the delay time (advDelay) after changing, the transmission interval (chInterval), and the transmission channel after changing included in the received transmission data. On the other hand, if it is no longer possible to receive the transmission data in step S410, it may return to intermittent reception with scan window width (SW1).

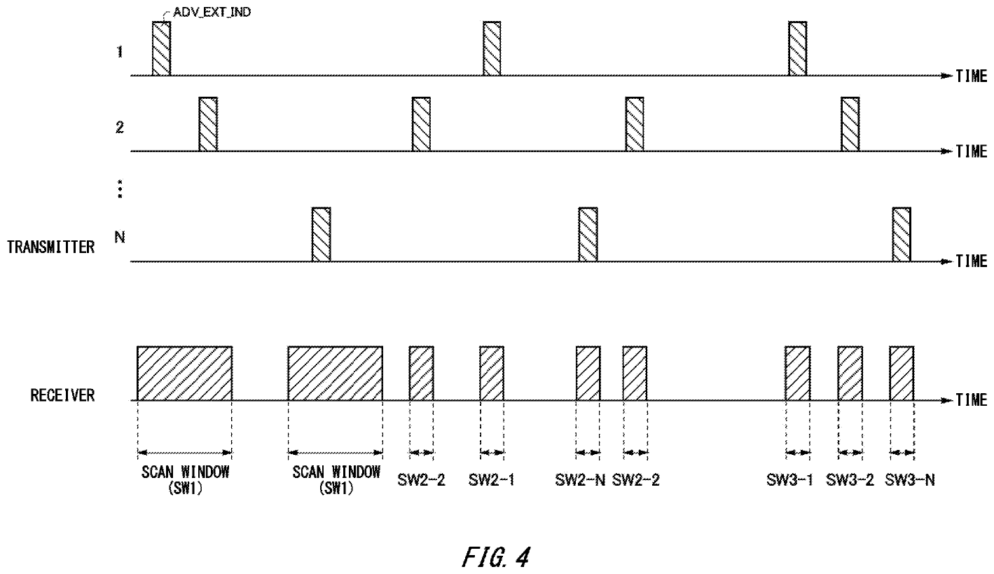

FIG. 4 illustrates one example of a synchronization method by the transmission and reception system 300. The transmission and reception system 300 of this example comprises N transmitters 100 and one receiver 200.

In the transmission and reception system 300, even when a plurality of transmitters 100 are provided, a single receiver 200 can operate intermittently. In the transmission and reception system 300 of this example, each of the plurality of transmitters 100 generates a beacon signal and the respective beacon signal is received by the receiving unit 210. The timing determination unit 220 determines the reception timing according to each beacon signal.

Each of the plurality of transmitters 100 performs advertising transmission in the ADV_EXT_IND data format. The transmission and reception system 300 of this example uses a plurality of channels of beacon signals (for example, three channels), but for simplicity, the transmission of ADV_EXT_IND is shown together in the drawing.

The transmitter 100 includes information about the transmission period (advInterval) and the delay time (advDelay) in the data format. The transmission period (advInterval) and the delay time (advDelay) of the data format may be different for each transmitter 100.

The receiver 200 continues to receive until all broadcasts have been received in the scan window width (SW1). The receiver 200 receives the transmission data from the transmitter 100 and obtains the transmission period (advInterval) and delay time (advDelay) of the data included in the received data to calculate the timing to open the next scan window. The receiver 200 may calculate the timing to open the scan window for each transmitter 100. The receiver 200 waits to receive at the timing corresponding to one channel of the plurality of channels in the transmitter 100 that is the target of communication.

The receiver 200 may also fix the scan window width to a predetermined width, or it may change the scan window width for each event. If the data length of each transmitter 100 is different, the scan window width may respectively be optimized for each transmitter 100. The receiver 200 in this example sets the scan window width SW2 according to the data length of the transmitter 100, and then sets a scan window width SW3 different from the scan window width SW2 in the next event. By changing the scan window width for each event, the power consumption of the receiver 200 can be further reduced.

The transmission and reception system 300 in this example can operate intermittently with one receiver 200, even when equipped with a plurality of transmitters 100. This allows the transmission and reception system 300 to achieve low power consumption.

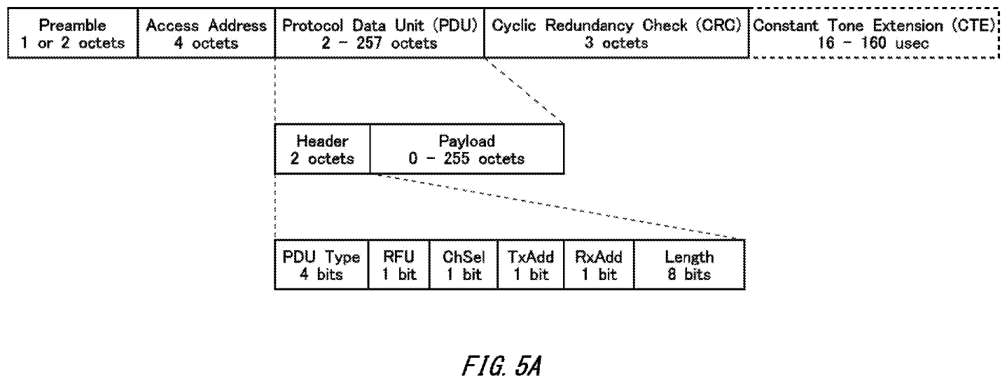

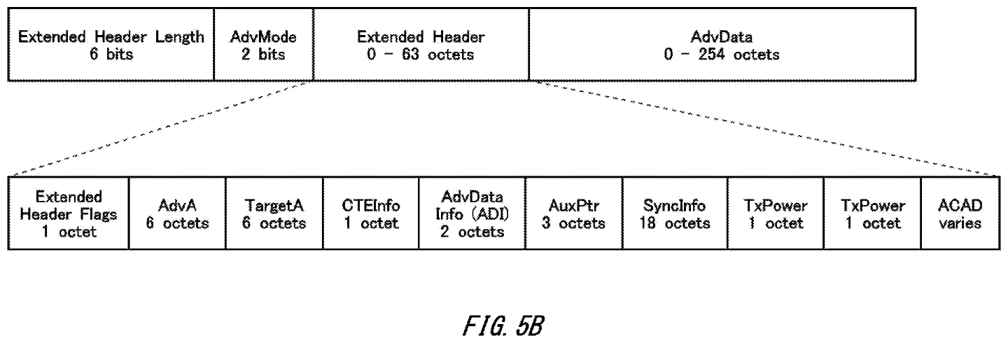

FIG. 5A illustrates a packet format of Bluetooth 5.1. Bluetooth 5.1 includes a preamble, an access address, a protocol data unit (PDU), and a cyclic redundancy check (CRC). Bluetooth 5.1 also includes a CTE, which is a section where a single data tone is transmitted.

The preamble may be one or two octets. In the case of one octet, the Preamble is 8′ hAA or 8′ h55. In the case of two octets, the Preamble is 8′ hAAAA or 8′ h5555. The Preamble may be determined by the first bit value of the access address.

The access address is set to the SyncInfo value of AUX_ADV_IND for AUX_SYNC_IND. All other packets are 32′ h8E89BED6.

The ChSel of the header is 1′ b0. The TxAdd of the header is 1′ b0 if AdvA is a public address, and 1′ b1 if AdvA is a random address.

The RxAdd of the header is 1′ b0. The length of the header specifies the payload length. RFU indicates Reserved for Future Use.

FIG. 5B illustrates one example of a configuration of the Payload. The Payload in this example is a configuration of the Common Extended Advertising Payload Format. The payload in this example is an example of the configuration of the payload of ADV_EXT_IND, AUX_ADV_IND and AUX_SYNC_IND.

Table 1 shows an example of the packet format before transmitting AUX_SYNC_IND specified in the standard.

TABLE 1

| | Adv | Adv | Tartget | CTE | | Aux | Sync | Tx | | Adv |
|---|---|---|---|---|---|---|---|---|---|---|
| | Mode | A | A | Info | ADI | Ptr | Info | Power | ACAD | Data |
| ADV_EXT_IND | 2'b00 | M | X | X | X | X | X | O | X | X |
| AUX_ADV_IND | 2'b00 | O | X | X | M | O | O | O | O | O |
| AUX_SUNC_IND | 2'b00 | X | X | O | X | O | X | O | O | O |

M: Mandatory
O: Optional
X: RFU

Table 2 shows an example of the packet format used in the transmission and reception system 300. The packet format of the transmission and reception system 300 may be ADV_EXT_IND. The transmission and reception system 300 inserts CTEInfo into ADV_EXT_IND and sets it to CTE transmission. Also, the transmission and reception system 300 performs transmission with information on the transmission period (advInterval) and delay time (advDelay) in either the ACAD or AdvData included therein.

TABLE 2

| | Adv | Adv | Tartget | CTE | | Aux | Sync | Tx | | Adv |
|---|---|---|---|---|---|---|---|---|---|---|
| | Mode | A | A | Info | ADI | Ptr | Info | Power | ACAD | Data |
| ADV_EXT_IND | 2'b00 | M | X | Set | X | X | X | O | O | O |

M: Mandatory
O: Optional
X: RFU

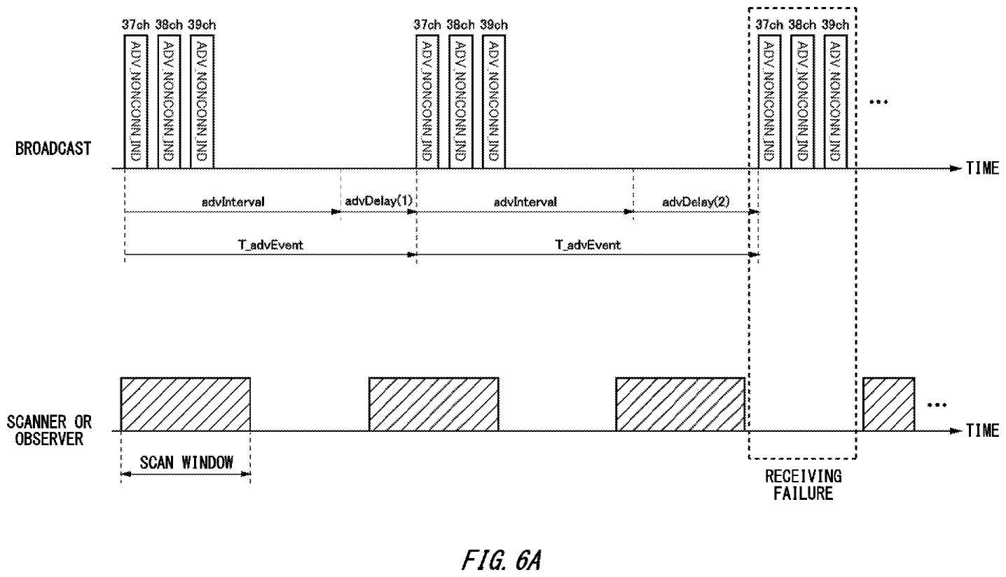

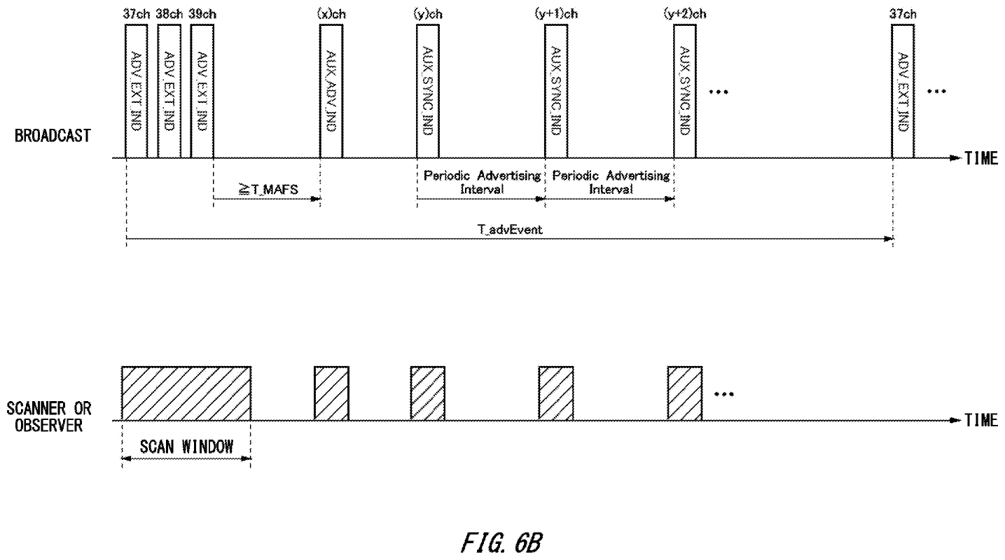

FIG. 6A illustrates one example of a timing synchronization method according to a comparative example. This example illustrates one example of the advertising transmission of the BLE beacon.

The broadcaster is a BLE beacon that performs advertising transmission with a transmission format for a beacon transmission called ADV_NONCONN_IND. However, the broadcaster in this example uses a data format that does not correspond to CTE transmission. The broadcaster in this example combines three channels (37 ch, 38 ch and 39 ch) for advertising transmission, and then performs the next advertising transmission after the transmission period (advInterval) and the delay time (advDelay) time has elapsed.

The scanner or observer opens a scan window of a predetermined width and waits for reception. The scanner or observer waits for reception in intermittent operation for low power consumption.

The timing synchronization method in this example uses a pseudo-random delay and since the transmitting side only broadcasts, the timing of transmission and reception is completely asynchronous. This thereby makes it difficult to synchronize between transmission and reception, and the scan window is required to always be open in order to receive all transmissions. Therefore, the timing synchronization method according to the comparative example cannot reduce power consumption.

FIG. 6B illustrates one example of a timing synchronization method according to the comparative example. This example illustrates a synchronization method (periodic advertising) for the direction detection.

The broadcaster uses three types of formats, ADV_EXT_IND, AUX_ADV_IND and AUX_SYNC_IND, for direction detection by AoA and AoD. Any of the three formats of this example corresponds to the CTE transmission.

The broadcaster transmits data containing predetermined information in ADV_EXT_IND. The ADV_EXT_IND in this example includes information on the channel used in the AUX_ADV_IND, the offset to the AUX_ADV_IND and the physical layer used (1 Mbps or 2 Mbps). The broadcaster in this example combines three channels, 37 ch, 38 ch and 39 ch, for advertising transmission.

Next, the broadcaster transmits data including predetermined information in AUX_ADV_IND. The AUX_ADV_IND in this example includes information on the offset to AUX_SYNC_IND, the transmission interval of AUX_SYNC_IND, the channel map, the event counter and the address to be accessed. The broadcaster in this example is using xch, a channel for data communication other than the three channels used in ADV_EXT_IND, which are 37 ch, 38 ch, and 39 ch, for advertising transmission.

Then, the broadcaster then transmits AUX_SYNC_IND at a predetermined transmission interval. The broadcaster switches the channel for data communication and transmits AUX_SYNC_IND. The broadcaster in this example changes the channels in the order of (y)-ch, (y+1)-ch, and (y+2)-ch.

The scanner or observer may open the scan window at the appropriate timing, since the timing of the transmission is known. This can reduce the power consumption of the receiving side.

However, in order to synchronize between transmission and reception, the broadcaster has to correspond to three types of data formats. In addition, the power consumption of the broadcaster cannot be reduced because the frequency of transmission increases with the transmission of a plurality of formats.

In addition, the receiving process is complicated because the scanner or observer has to read three types of data formats and set the scan window appropriately while switching the channel to be used. For AUX_ADV_IND and AUX_SYNC_IND, it is necessary to use the channels for data communication instead of the three channels from 37ch to 39ch that were used for advertising transmission. Channels other than the three channels 37ch to 39ch are susceptible to interference from other 2.4 GHz bands such as Wi-Fi (registered trademark), so stable communication may not be possible in some environments.

In contrast, the transmission and reception system 300 can synchronize the timing without having to deal with a plurality of data formats, thus reducing the power consumption of the transmitter 100. In addition, the transmission and reception system 300 can use the advertising transmission channel to achieve stable communication because it does not need to use the channel for data communication. Furthermore, the transmission and reception system 300 can reduce the power consumption of the receiver 200 by including the transmission period (advInterval) and delay time (advDelay) in the transmission data of the advertising transmission. In this way the transmission and reception system 300 can achieve low power consumption by realizing direction detection using only the transmission channel for advertising.

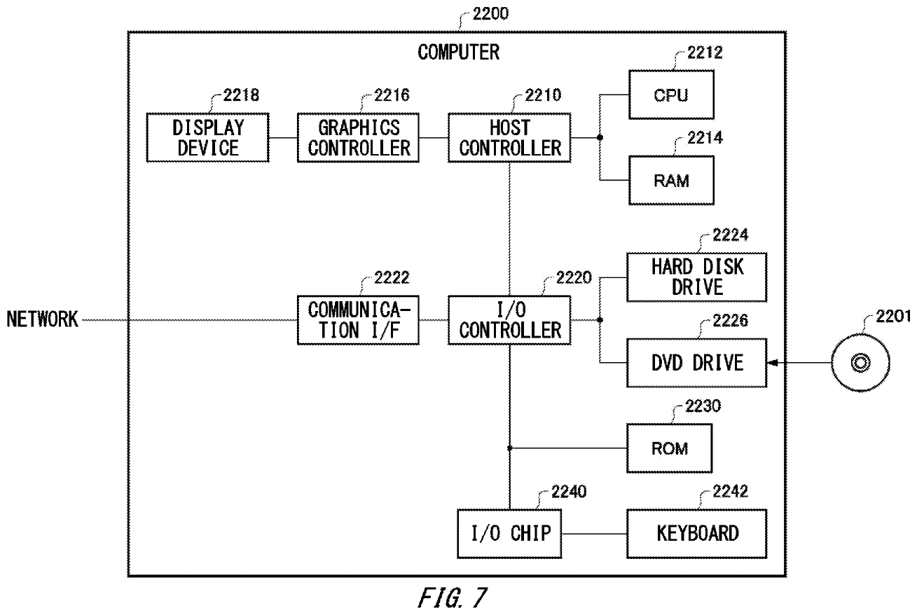

FIG. 7 illustrates an example of a computer 2200 in which a plurality of aspects of the present invention may be embodied entirely or partially. The program installed on the computer 2200 can cause the computer 2200 to function as an operation associated with an apparatus according to an embodiment of the present invention or one or more sections of such an apparatus, or to perform such an operation or such one or more sections, and/or to cause the computer 2200 to perform a process or a step of the process in accordance with an embodiment of the present invention. Such a program may be executed by the CPU 2212 to cause the computer 2200 to perform certain operations associated with some or all of the blocks of the flowcharts and block diagrams described herein.

The computer 2200 according to the present embodiment includes a CPU 2212, a RAM 2214, a graphic controller 2216, and a display device 2218, which are mutually connected by a host controller 2210. The computer 2200 also includes an input/output unit such as a communication interface 2222, a hard disk drive 2224, a DVD-ROM drive 2226, and an IC card drive, which are connected to the host controller 2210 via a input/output controller 2220. The computer also includes a legacy input/output unit such as the ROM 2230 and a keyboard 2242, which are connected to the input/output controller 2220 via the input/output chip 2240.

The CPU 2212 operates according to the programs stored in the ROM 2230 and the RAM 2214, thereby controlling each unit. The graphics controller 2216 acquires the image data generated by the CPU 2212 in a frame buffer or the like provided in RAM 2214 or in itself, and causes the image data to be displayed on the display device 2218.

The communication interface 2222 communicates with other electronic devices over a network. The hard disk drive 2224 stores programs and data used by the CPU 2212 within the computer 2200. The DVD-ROM drive 2226 reads the programs or the data from the DVD-ROM 2201, and provides the hard disk drive 2224 with the programs or the data via the RAM 2214. The IC card drive reads the program and data from an IC card, and/or writes the program and data to the IC card.

The ROM 2230 stores therein a boot program or the like executed by the computer 2200 at the time of activation, and/or a program depending on the hardware of the computer 2200. The input/output chip 2240 may also connect various input/output units to the input/output controller 2220 via a parallel port, serial port, keyboard port, mouse port, or the like.

The program is provided by a computer readable medium such as DVD-ROM 2201 or IC card. The program is read from a computer readable medium, installed in a hard disk drive 2224, RAM 2214, or ROM 2230, which are also examples of computer readable media, and executed by the CPU 2212. Information processing written in these programs is read by the computer 2200, resulting in cooperation between a program and various types of hardware resources described above. The device or method may consist of realizing the operations or processing of information according to the use of the computer 2200.

For example, when communication is performed between the computer 2200 and an external device, the CPU 2212 may execute a communication program loaded onto the RAM 2214 to instruct communication processing to the communication interface 2222, based on the processing described in the communication program. The communication interface 2222, under the control of the CPU 2212, reads the transmission data stored in the transmission buffer processing area provided in the recording medium such as RAM 2214, hard disk drive 2224, DVD-ROM 2201, or IC card, and transmits the read transmission data to the network, or writes the received data received from the network to the reception buffer processing area provided on the recording medium or the like.

In addition, the CPU 2212 may cause all or a necessary portion of a file or a database to be read into the RAM 2214, the file or the database having been stored in an external recording medium such as the hard disk drive 2224, the DVD-ROM drive 2226 (DVD-ROM 2201), the IC card, and the like, and perform various types of processing on the data on the RAM 2214. Then, the CPU 2212 writes back the processed data to the external recording medium.

Various types of information such as various types of programs, data, tables, and databases may be stored in recording media and subjected to the information process. The CPU 2212 may perform various types of processing on data read from the RAM 2214 including various types of operations, information processing, conditional determination, conditional branching, unconditional branching, information search/replacement, etc., which are described throughout the present disclosure and designated by an instruction sequence of the program, and the results may be written back to the RAM 2214. Further, the CPU 2212 may search for information in the file, the database, or the like in the recording medium. For example, when a plurality of entries each having an attribute value of a first attribute associated with an attribute value of a second attribute are stored in the recording medium, the CPU 2212 may search, from among the plurality of entries, for an entry matching a condition in which the attribute value of the first attribute is specified, and read the attribute value of the second attribute stored in the entry thereby acquiring the attribute value of the second attribute associated with the first attribute that satisfies a predetermined condition.

The above-described programs or software module may be stored on the computer 2200 or in the computer readable medium in the vicinity of the computer 2200. In addition, a recording medium such as a hard disk or RAM provided in a server system connected to a dedicated communication network or the Internet can be used as a computer readable medium, thereby providing the program to the computer 2200 via the network.

While the embodiments of the present invention have been described, the technical scope of the present invention is not limited to the above described embodiments. It is apparent to persons skilled in the art that various alterations or improvements can be added to the above-described embodiments. It is also apparent from the scope of the claims that the embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A timing synchronization method, comprising:
setting a transmission period and a delay time of a beacon signal to be transmitted by a transmitter;
generating and transmitting, by the transmitter, a beacon signal in a data format including the transmission period and the delay time;
receiving, by a receiver, the beacon signal;
determining, by the receiver, a reception timing of a next beacon signal to be transmitted by the transmitter based on an event time obtained by adding the delay time to the transmission period; and
generating and transmitting, by the transmitter, the next beacon signal at the event time.

2. The timing synchronization method according to claim 1, comprising:
changing the delay time by the transmitter;
transmitting, by the transmitter, the beacon signal including the delay time after changing; and
receiving the beacon signal, and determining, by the receiver, a reception timing based on the event time according to the delay time that has been changed.

3. The timing synchronization method according to claim 1,
wherein generating the beacon signal includes generating beacon signals of a plurality of channels,
the timing synchronization method comprising
changing a combination of the plurality of channels and transmitting the beacon signal by the transmitter.

4. The timing synchronization method according to claim 2,
wherein generating the beacon signal includes generating beacon signals of a plurality of channels,
the timing synchronization method comprising
changing a combination of the plurality of channels and transmitting the beacon signal by the transmitter.

5. The timing synchronization method according to claim 3, wherein generating the beacon signal includes generating the beacon signal in the data format that further includes a first combination of the plurality of channels, a second combination of the plurality of channels for transmission next to the first combination, and a transmission interval of the plurality of channels.

6. The timing synchronization method according to claim 1, wherein
generating the beacon signal includes generating the beacon signal by each of a plurality of the transmitters, and
the receiver is configured to determine a reception timing according to each of the beacon signals generated by a plurality of the transmitters.

7. The timing synchronization method according to claim 2, wherein
generating the beacon signal includes generating the beacon signal by each of a plurality of the transmitters,
the receiver is configured to determine a reception timing according to each of the beacon signal generated by a plurality of the transmitters.

8. The timing synchronization method according to claim 1,
wherein the transmitter
is configured to generate a beacon signal in a data format including the transmission period and the delay time stored in a payload when generating a beacon signal.

9. The timing synchronization method according to claim 1, wherein the determining further comprises
determining, by the receiver, a scan window width based on information about received data by the receiver.

10. A transmission and reception system comprising a transmitter and a receiver, wherein
the transmitter comprises
a setting unit for setting a transmission period and a delay time of a beacon signal to be transmitted;
a data generation unit for generating a beacon signal in a data format including the transmission period and the delay time stored in a payload; and
a transmitting unit for transmitting the beacon signal at an event time obtained by adding the delay time to the transmission period set by the setting unit when the transmitter transmitted the previous time;
the receiver comprises
a receiving unit for receiving the beacon signal; and
a timing determination unit for determining a reception timing based on the event time.

11. The transmission and reception system according to claim 10, wherein
the transmitter is configured to change the delay time, and transmit the beacon signal including the delay time that has been changed; and
the receiver is configured to receive the beacon signal, and determine the reception timing based on the event time according to the delay time that has been changed.

12. The transmission and reception system according to claim 10, wherein
the transmitter is configured to generate beacon signals of a plurality of channels, change a combination of the plurality of channels, and transmit the beacon signal.

13. The transmission and reception system according to claim 11, wherein
the transmitter is configured to generate beacon signals of a plurality of channels, change a combination of the plurality of channels, and transmit the beacon signal.

14. The transmission and reception system according to claim 12, wherein
the data generation unit is configured to generate the beacon signal in the data format that further includes a first combination of the plurality of channels, a second combination of the plurality of channels for transmission next to the first combination, and a transmission interval of the plurality of channels.

15. The transmission and reception system according to claim 10, comprising
a plurality of transmitters, each of which generates the beacon signal; wherein
the receiving unit is configured to receive each of the beacon signal generated by the plurality of transmitters; and
the timing determination unit is configured to determine the reception timing according to each of the beacon signal.

16. The transmission and reception system according to claim 11, comprising
a plurality of transmitters, each of which generates the beacon signal; wherein
the receiving unit is configured to receive each of the beacon signal generated by the plurality of transmitters; and
the timing determination unit is configured to determine the reception timing according to each of the beacon signal.

17. The transmission and reception system according to claim 10, wherein
the data generation unit is configured to
generate a beacon signal in a data format including the transmission period and the delay time stored in a payload.

18. The transmission and reception system according to claim 10, wherein
the timing determination unit is further configured to
determine a scan window width based on information about received data.

19. A non-transitory computer readable storage medium having recorded thereon a program that causes the computer to perform a timing synchronization method, comprising:
setting a transmission period and a delay time of a beacon signal to be transmitted by a transmitter;
generating and transmitting, by the transmitter, a beacon signal in a data format including the transmission period and the delay time;
receiving, by a receiver, the beacon signal;
determining, by the receiver, a reception timing of a next beacon signal to be transmitted by the transmitter based on an event time obtained by adding the delay time to the transmission period; and
generating and transmitting, by the transmitter, the next beacon signal at the event time.

20. The non-transitory computer readable storage medium according to claim 19, having recorded thereon a program that, when executed by a computer, causes the computer to perform a timing synchronization method, comprising:
changing the delay time by the transmitter;
transmitting, by the transmitter, the beacon signal including the delay time before changing;
receiving the beacon signal, and determining, by the receiver, a reception timing based on the event time according to the delay time that has been changed.
